(19) United States
(12) Patent Application Publication
(10) Pub. No.: US 2025/0254701 A1
(43) Pub. Date: Aug. 7, 2025

(54) METHODS AND APPARATUSES FOR DETERMINING TRANSMISSION DIRECTION

(71) Applicant: Lenovo (Beijing) Limited, Beijing (CN)

(72) Inventors: Yu Zhang, Beijing (CN); Haipeng Lei, Beijing (CN)

(73) Assignee: Lenovo (Beijing) Limited, Beijing (CN)

(21) Appl. No.: 18/856,168

(22) PCT Filed: Apr. 12, 2022
(86) PCT No.: PCT/CN2022/086341

§ 371 Date: Oct. 11, 2024

(51) Int. Cl. H04W 72/232; H04L 5/00; H04W 72/044

(52) U.S. Cl. CPC H04W 72/232; H04L 5/0005; H04W 72/044

(57) ABSTRACT

The present application relates to methods and apparatuses for determining a transmission direction. An embodiment of the present disclosure provides a user equipment (UE), comprising: a transceiver; and a processor coupled with the transceiver, and the processor is configured to: receive, with the transceiver, one or more indicators in a downlink control information (DCI) message, wherein the one or more indicators indicate a transmission direction configuration for a set of time-frequency domain resources; and determine a transmission direction corresponding to each time-frequency domain resource in the set of time-frequency domain resources at least based on the one or more indicators, wherein each time-frequency domain resource consists of one sub-band in frequency domain and one symbol in time domain.

### TECHNICAL FIELD

The present disclosure generally relates to communication technologies, and especially to methods and apparatuses for determining a transmission direction.

### BACKGROUND OF THE INVENTION

Time Division Duplexing (TDD) is widely used in wireless networks. When operating TDD in a wireless network, only one transmission direction, that is, downlink (DL) or uplink (UL) is supported in a given time duration. However, allocation of a limited time duration for the UL transmissions would result in reduced coverage and increased latency. Therefore, it would be worth allowing the simultaneous existence of DL transmissions and UL transmissions in a given time duration, a.k.a. full duplex. More specifically, sub-band non-overlapping full duplex mode can be implemented in a wireless network, that is, the network can support simultaneous UL transmissions and DL transmissions occupying the non-overlapping sub-bands.

For operating sub-band non-overlapping full duplex mode in a wireless network, it is important to indicate the transmission direction for multiple sub-bands to the devices in the wireless network such that the devices can perform the corresponding procedures, for example, perform UL transmissions or perform DL receptions.

### SUMMARY

An embodiment of the present disclosure provides a user equipment (UE), comprising: a transceiver; and a processor coupled with the transceiver, and the processor is configured to: receive, with the transceiver, one or more indicators in a downlink control information (DCI) message, wherein the one or more indicators indicate a transmission direction configuration for a set of time-frequency domain resources; and determine a transmission direction corresponding to each time-frequency domain resource in the set of time-frequency domain resources at least based on the one or more indicators, wherein each time-frequency domain resource consists of one sub-band in frequency domain and one symbol in time domain.

In some embodiments, the one or more indications include a slot format indicator (SFI), and wherein the SFI indicates a transmission direction for each time-frequency domain resource in the set of time-frequency domain resources.

In some embodiments, the one or more indications further include a sub-band pattern indicator (SPI) indicating a transmission direction for each time-frequency domain resource in a first subset of the set of time-frequency domain resources.

In some embodiments, the SPI indicates one or more sub-band patterns, wherein each sub-band pattern includes a set of fields, and wherein each field indicates a transmission direction for each time-frequency domain resource in a second subset of the first subset of time-frequency domain resources.

In some embodiments, the processor is further configured to: in the case that the SFI indicates a first transmission direction corresponding to a first time-frequency domain resource, determine the transmission direction corresponding to the first time-frequency domain resource is the first transmission direction; in the case that the SFI indicates a second transmission direction n corresponding to a second time-frequency domain resource, and the SPI indicates the first transmission direction or the second transmission direction corresponding to the second time-frequency domain resource, determine the transmission direction of the second time-frequency domain resource is the first transmission direction or the second transmission direction as indicated by the SPI, wherein the second time-frequency domain resource is included in the first subset of the set of time-frequency domain resources; or in the case that the SFI indicates the second transmission direction corresponding to a third time-frequency domain resource, determine the transmission direction of the third time-frequency domain resource is the second transmission direction, wherein the third time-frequency domain resource is not included in the first subset of the set of time-frequency domain resources.

In some embodiments, the processor is further configured to: determine a transmission direction for each time-frequency domain resource in a second subset of the first subset of time-frequency domain resources based on a pre-defined rule.

In some embodiments, the processor is further configured to: determine a first priority level associated with a first transmission on a first set of resource elements (REs); determine a second priority level associated with a second transmission on a second set of REs; and perform a transmission with a higher priority level among the first transmission and the second transmission in response to a resource collision being present between the first transmission and the second transmission.

In some embodiments, the resource collision is determined based on: a time gap between the first set of REs and the second set of REs in time domain being less than a preconfigured duration; or the first set of REs and the second set of REs at least partially overlapped in time domain.

Another embodiment of the present disclosure provides a base station (BS), comprising: a transceiver; and a processor coupled with the transceiver, and the processor is configured to: transmit a DCI message including one or more indicators, wherein the one or more indicators indicate a transmission direction configuration for a set of time-frequency domain resources.

In some embodiments, the one or more indications include an SFI, and wherein the SFI indicates a transmission direction for each time-frequency domain resource in the set of time-frequency domain resources.

In some embodiments, the one or more indications further include an SPI indicating a transmission direction for each time-frequency domain resource in a first subset of the set of time-frequency domain resources.

In some embodiments, the SPI indicates one or more sub-band patterns, wherein each sub-band pattern includes a set of fields, and wherein each field indicates a transmission direction for each time-frequency domain resource in a second subset of the first subset of time-frequency domain resources.

Yet another embodiment of the present disclosure provides a method performed by a UE, comprising: receiving, with the transceiver, one or more indicators in a DCI message, wherein the one or more indicators indicate a transmission direction configuration for a set of time-frequency domain resources; and determining a transmission direction corresponding to each time-frequency domain resource in the set of time-frequency domain resources at least based on the one or more indicators, wherein each time-frequency domain resource consists of one sub-band in frequency domain and one symbol in time domain.

In some embodiments, the one or more indications include an SFI, and wherein the SFI indicates a transmission direction for each time-frequency domain resource in the set of time-frequency domain resources.

In some embodiments, the one or more indications further include a SPI indicating a transmission direction for each time-frequency domain resource in a first subset of the set of time-frequency domain resources.

In some embodiments, the SPI indicates one or more sub-band patterns, wherein each sub-band pattern includes a set of fields, and wherein each field indicates a transmission direction for each time-frequency domain resource in a second subset of the first subset of time-frequency domain resources.

In some embodiments, the method further includes: in the case that the SFI indicates a first transmission direction corresponding to a first time-frequency domain resource, determining the transmission direction corresponding to the first time-frequency domain resource is the first transmission direction; in the case that the SFI indicates a second transmission direction corresponding to a second time-frequency domain resource, and the SPI indicates the first transmission direction or the second transmission direction corresponding to the second time-frequency domain resource, determining the transmission direction of the second time-frequency domain resource is the first transmission direction or the second transmission direction as indicated by the SPI, wherein the second time-frequency domain resource is included in the first subset of the set of time-frequency domain resources; or in the case that the SFI indicates the second transmission direction corresponding to a third time-frequency domain resource, determining the transmission direction of the third time-frequency domain resource is the second transmission direction, wherein the third time-frequency domain resource is not included in the first subset of the set of time-frequency domain resources.

In some embodiments, the method further includes: determining a transmission direction for each time-frequency domain resource in a second subset of the first subset of time-frequency domain resources based on a pre-defined rule.

In some embodiments, the method further includes: determining a first priority level associated with a first transmission on a first set of REs; determining a second priority level associated with a second transmission on a second set of REs; and performing a transmission with a higher priority level among the first transmission and the second transmission in response to a resource collision being present between the first transmission and the second transmission.

In some embodiments, the resource collision is determined based on: a time gap between the first set of REs and the second set of REs in time domain being less than a preconfigured duration; or the first set of REs and the second set of REs at least partially overlapped in time domain.

Still another embodiment of the present disclosure provides a method performed by a base station (BS), comprising: transmitting a DCI message including one or more indicators, wherein the one or more indicators indicate a transmission direction configuration for a set of time-frequency domain resources.

In some embodiments, the one or more indications include an SFI, and wherein the SFI indicates a transmission direction for each time-frequency domain resource in the set of time-frequency domain resources.

In some embodiments, the one or more indications further include an SPI indicating a transmission direction for each time-frequency domain resource in a first subset of the set of time-frequency domain resources.

In some embodiments, the SPI indicates one or more sub-band patterns, wherein each sub-band pattern includes a set of fields, and wherein each field indicates a transmission direction for each time-frequency domain resource in a second subset of the first subset of time-frequency domain resources.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates an exemplary wireless communications system in accordance with some embodiments of the present disclosure.

FIG. 2 illustrates an exemplary allocation of sets of REs corresponding to simultaneous UL and DL transmissions when operating a sub-band non-overlapping full duplex mode.

FIG. 3 illustrates an exemplary slot format for a slot according to some embodiments of the present disclosure.

FIGS. 4A and 4B illustrate exemplary sub-bands configurations according to some embodiments of the present disclosure.

FIGS. 5A-5D illustrate some exemplary transmission direction configurations according to some embodiments of the present disclosure.

FIGS. 6A-6D illustrate some exemplary transmission direction configurations according to some embodiments of the present disclosure.

FIGS. 7A and 7B illustrate some exemplary cases of resource collision according to some embodiments of the present disclosure.

FIG. 8 illustrates a flow chart of an exemplary procedure of wireless communications in accordance with some embodiments of the present disclosure.

FIG. 9 illustrates a simplified block diagram of an exemplary apparatus according to some embodiments of the present disclosure.

### DETAILED DESCRIPTION

The detailed description of the appended drawings is intended as a description of the currently preferred embodiments of the present invention, and is not intended to represent the only form in which the present invention may be practiced. It should be understood that the same or equivalent functions may be accomplished by different embodiments that are intended to be encompassed within the spirit and scope of the present invention.

While operations are depicted in the drawings in a particular order, persons skilled in the art will readily recognize that such operations need not be performed in the particular order shown or in sequential order, or that among all illustrated operations, to achieve desirable results, sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present disclosure, examples of which are illustrated in the accompanying drawings. To facilitate understanding, embodiments are provided under specific network architecture and new service scenarios, such as 3rd generation partnership project (3GPP) long-term evolution (LTE) and LTE Advanced, 3GPP 5G new radio (NR), 5G-Advanced, 6G and so on. It is contemplated that along with the developments of network architectures and new service scenarios, all embodiments in the present disclosure are also applicable to similar technical problems; and moreover, the terminologies recited in the present disclosure may change, which should not affect the principle of the present disclosure.

FIG. 1 illustrates an exemplary wireless communications system 100 in accordance with some embodiments of the present disclosure.

Referring to FIG. 1, the wireless communications system 100 may include one or more UEs (e.g., UE 101-A and UE 101-B, collectively referred to as UEs 101), and at least a BS 102. Although a specific number of UEs 101 and BS 102 are depicted in FIG. 1, it is contemplated that any number of UEs and BSs may be included in the wireless communications system 100.

In some embodiments of the present disclosure, the UEs 101 may be devices in different forms or having different capabilities. According to some embodiments of the present disclosure, the UEs 101 may include or may be referred to as computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present disclosure, the UEs 101 may include or may be referred to as portable wireless communication devices, such as smart phones, cellular telephones, flip phones, or any other device that is capable of transmitting and receiving information. In some embodiments, the UEs 101 may include or may be referred to as wearable devices, such as smart watches, fitness bands, optical head-mounted displays, or the like. Moreover, the UEs 101 may be referred to as a subscriber unit, a mobile, a mobile station, a user, a terminal, a mobile terminal, a wireless terminal, a fixed terminal, a subscriber station, a user terminal, or a device, or described using other terminology used in the art.

In some embodiments of the present disclosure, the BS 102 may be referred to as an access point, an access terminal, a base, a base unit, a macro cell, a Node B, an enhanced Node B, an evolved Node B, a next generation Node B (gNB), a Home Node B, a relay node, or a device, or described using other terminology used in the art. The BS 102 is generally a part of a radio access network that may include one or more controllers communicably coupled to one or more corresponding BS 102.

The wireless communications system 100 may be compatible with any type of network that is capable of exchanging information between the BS 102 and the UEs 101. For example, the wireless communications system 100 may be a cellular telephone network, a time division multiple access (TDMA)-based network, a code division multiple access (CDMA)-based network, an orthogonal frequency division multiple access (OFDMA)-based network, a 3GPP-based network, a 3GPP LTE network, a 3GPP 5G NR network, a satellite communications network, a high-altitude platform network, or one of other communications networks. More generally, however, the wireless communications system 100 may implement some other open or proprietary communication protocols, for example, IEEE 802.11 family, WiMAX, among other protocols.

In some embodiments of the present disclosure, the BS 102 may be dispersed throughout a geographic area to form the wireless communications system 100 and may be a device in different forms or having different capabilities. The information exchanges between the BS 102 and the UEs 101 in the wireless communications system 100 may include uplink (UL) transmissions (e.g., UL transmission 111-a and UL transmission 111-b, collectively referred to UL transmissions 111) from the UEs 101 to the BS 102, or downlink (DL) transmissions 112 from the BS 102 to the UEs 101 (e.g., DL transmission 112-a and DL transmission 112-b, collectively referred to DL transmissions 112) over one or more carriers. A carrier may be a portion of a radio frequency spectrum band and may be associated with a particular bandwidth (e.g., 20 megahertz (MHz)). A carrier may be made up of multiple subcarriers and a resource block (RB) is defined as 12 consecutive subcarriers. In some examples, there may be multiple sub-bands within a carrier and each sub-band may include a number of consecutive RBs. The time intervals for the wireless communications system 100 may be expressed in multiples of a basic time unit and may be organized according to radio frames each having a specified duration (e.g., 10 milliseconds (ms)). In some examples, a radio frame may be divided into subframes, and each subframe may be further divided into a number of slots. Alternatively, each radio frame may include a variable number of slots and each slot includes a number of symbols (e.g., 14 symbols). The UL and DL transmissions may include physical channel transmissions and physical signal transmissions. A physical channel transmission or a physical signal transmission is transmitted on a set of basic time-frequency domain resources having a defined physical layer structure. Each basic time-frequency domain resource may be referred to as a resource element (RE) which may consist of one symbol in time domain and one subcarrier in frequency domain. A set of REs corresponding to a physical channel transmission or a physical signal transmission may span a number of symbols within a slot in time domain and a number of subcarriers within one or more sub-bands in frequency domain, that is, the physical channel transmission or the physical signal transmission may be transmitted in a number of symbols and within one or more sub-bands.

In some embodiments of the present disclosure, for the wireless communications system 100, a sub-band non-overlapping full duplex mode may be supported for enhanced coverage, reduced latency, improved system capacity, and improved configuration flexibility, that is, there may be simultaneous UL transmission(s) 111-a from the UE 101-a to the BS 102 and DL transmission(s) 112-b from the BS 102 to the UE 101-b, and the UL transmission(s) 111-a and the DL transmission(s) 112-b are transmitted within non-overlapping sub-bands.

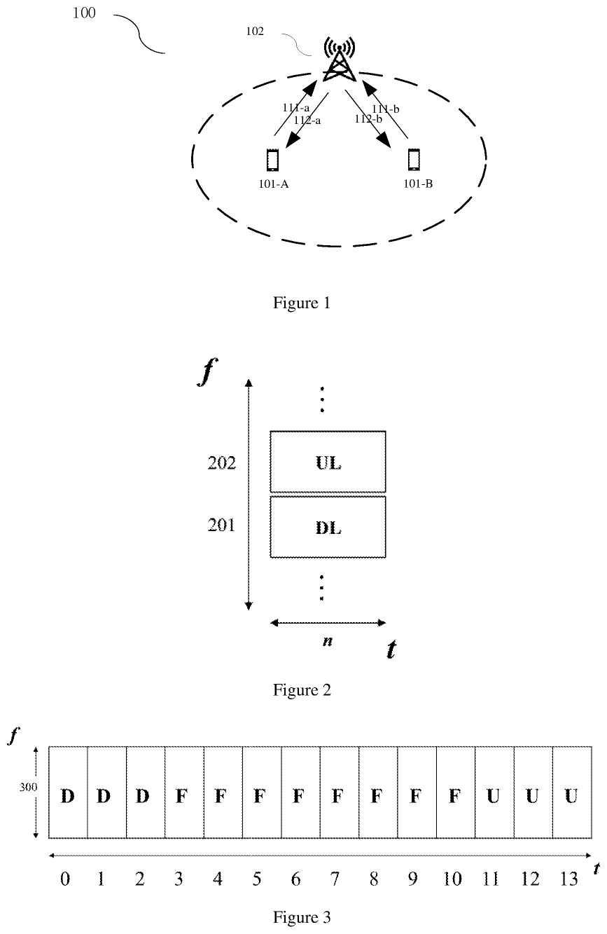

FIG. 2 illustrates an exemplary allocation of sets of REs corresponding to simultaneous UL and DL transmissions when operating a sub-band non-overlapping full duplex mode. In the example of FIG. 2, slot #n is shown in time domain (i.e., the horizontal axis marked by “t”), and non-overlapping sub-band 201 and sub-band 202 are shown in frequency domain (i.e., the vertical axis marked by “f”). A DL transmission (e.g., DL transmission 112-b) may be transmitted in the slot #n within the sub-band 201, and a UL transmission (e.g., UL transmission 111-a) may be transmitted in the slot #n within the sub-band 202.

In some embodiments of the present disclosure, in the wireless communications system 100, for a carrier, a UE can be provided with one or more slot formats after receiving a first DCI message and a higher layer signaling. The first DCI message may be a group common (GC) DCI message and may be carried by a GC-PDCCH. For the carrier, a slot format can indicate a transmission direction for each symbol in a slot, and the transmission direction can be downlink, uplink or flexible. In other words, each indicated transmission direction corresponds to a specific time-frequency domain resource which consists of a carrier in frequency domain and a symbol in time domain. For example, for a carrier 300, a slot format “DDDFFFFFFFFUUU” for a slot including 14 symbols (i.e., symbol #0 to symbol #13) is shown in FIG. 3, wherein “D” denotes a downlink transmission direction, “U” denotes an uplink transmission direction, and “F” denotes a flexible transmission direction.

More specifically, for the carrier, the UE may be configured by the higher layer signaling with a location of a slot format indicator (SFI)-index field (also referred to as SFI) in the first DCI message. The UE may also be configured by the higher layer signaling with a set of slot format combinations. Each slot format combination in the set of slot format combinations may include:
1. one or more slot formats; and
2. a mapping for the slot format combination to a value of the corresponding SFI-index field in the first DCI message.

After receiving the first DCI message in a first slot, the UE may find a value of the SFI according to the configured location of the SFI in the first DCI message, and may further determine the configured one or more slot formats included in the slot format combination corresponding to the value of the SFI for one or more consecutive slots starting from the first slot. The number of the one or more consecutive slots equals the number of the one or more slot formats corresponding to the value of the SFI. In other words, the SFI in the first DCI message indicates to the UE a slot format for each slot of a number of consecutive slots starting from the first slot, and the number of the consecutive slots equals to the number of the one or more slot formats corresponding to the value of the SFI. For example, in the case that the UE detects the first DCI message at slot #n, and the value of the SFI in the first DCI message corresponds to a slot format combination including three slot formats, the UE may determine three slot formats for slot #n, slot #n+1, and slot #n+2.

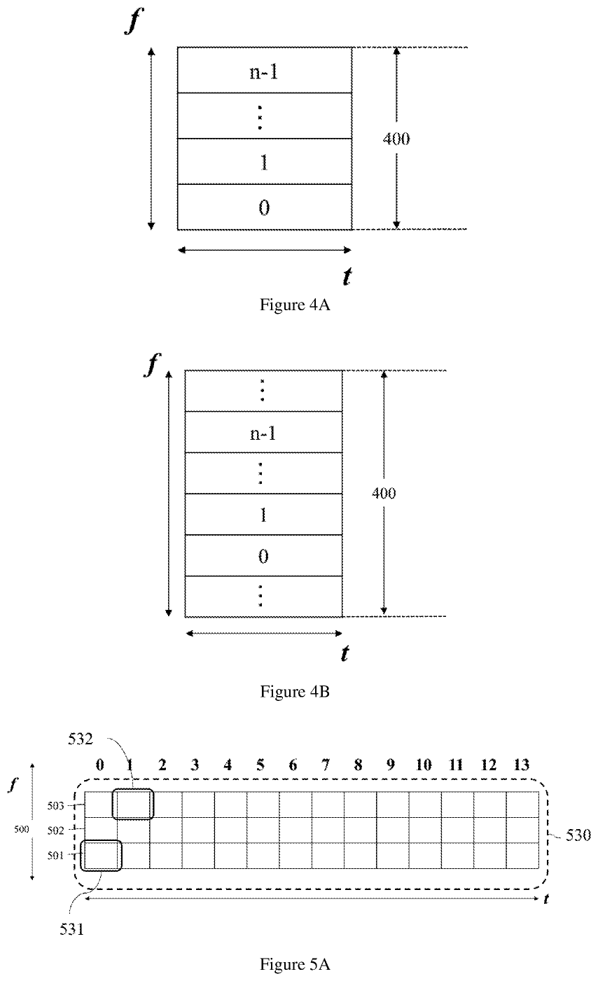

In some embodiments of the present disclosure, for the wireless communications system 100, a UE can determine that there are one or more sub-bands within a carrier. FIGS. 4A and 4B illustrate exemplary sub-bands configurations according to some embodiments of the present disclosure.

In FIGS. 4A and 4B, a carrier 400 is shown in the frequency domain. A UE may determine n sub-bands (e.g., sub-bands #0, #1, . . . , #n−1) within the carrier 400, where n is a positive integer. The total bandwidth of the n sub-bands may be equal to or less than the bandwidth of the carrier 400. In the example of FIG. 4A, the UE determines that the whole carrier 400 splits into n sub-bands, i.e., the total bandwidth of the n sub-bands is equal to the bandwidth of the carrier 400. In the example of FIG. 4B, the UE determines that a part of the carrier 400 splits into n sub-bands, i.e., the total bandwidth of the n sub-bands is less than the bandwidth of the carrier 400.

In some embodiments of the present disclosure, for the wireless communications system 100, in some examples, the UE 101 may be indicated to transmit at least one UL transmission (e.g., a physical uplink shared channel (PUSCH) transmission) on a set of REs after receiving a second DCI message from the BS 102. In some other examples, the UE 101 may be indicated to transmit at least one UL transmission (e.g., a physical uplink control channel (PUCCH) transmission) on a set of REs after receiving a higher layer signaling and a third DCI message from the BS 102. In some other examples, the UE 101 may be indicated to transmit at least one UL transmission (e.g., a PUCCH transmission) on a set of REs after receiving a higher layer signaling from the BS 102.

In some other embodiments of the present disclosure, for the wireless communications system 100, in some examples, the UE 101 may be indicated to receive at least one DL transmission (e.g., a physical downlink shared channel (PDSCH) transmission) on a set of REs after receiving a third DCI message from the BS 102. In some other examples, the UE 101 may be indicated to receive at least one DL transmission (e.g., a physical downlink reference signal transmission) on a set of REs after receiving a higher layer signaling and a third DCI message from the BS 102. In some other examples, the UE 101 may be indicated to receive at least one DL transmission (e.g., a physical downlink reference signal transmission) on a set of REs after receiving a higher layer signaling from the BS 102. In the context of the present disclosure, for a UE, transmitting a UL transmission may also be referred to as performing a UL transmission or the like, and receiving a DL transmission may also be referred to as performing a DL reception or the like; for a BS, transmitting a DL transmission may also be referred to as performing a DL transmission or the like, and receiving a UL transmission may also be referred to as performing a UL reception or the like.

The present disclosure provides various solutions for supporting sub-band non-overlapping full duplex mode for enhanced coverage, reduced latency, improved system capacity, and improved configuration flexibility. For operating sub-band non-overlapping full duplex mode, it is important to indicate a transmission direction configuration corresponding to a set of time-frequency resources, wherein each time-frequency resource in the set of time-frequency domain resources consists of one sub-band in frequency domain and one symbol in time domain.

Based on the transmission direction configuration, which is indicated by a first DCI message, a UE can determine a transmission direction for each time-frequency domain resource in the set of time-frequency domain resources. The set of time-frequency domain resources spans one or more slots in time domain and one or more sub-bands in frequency domain.

### Solution 1

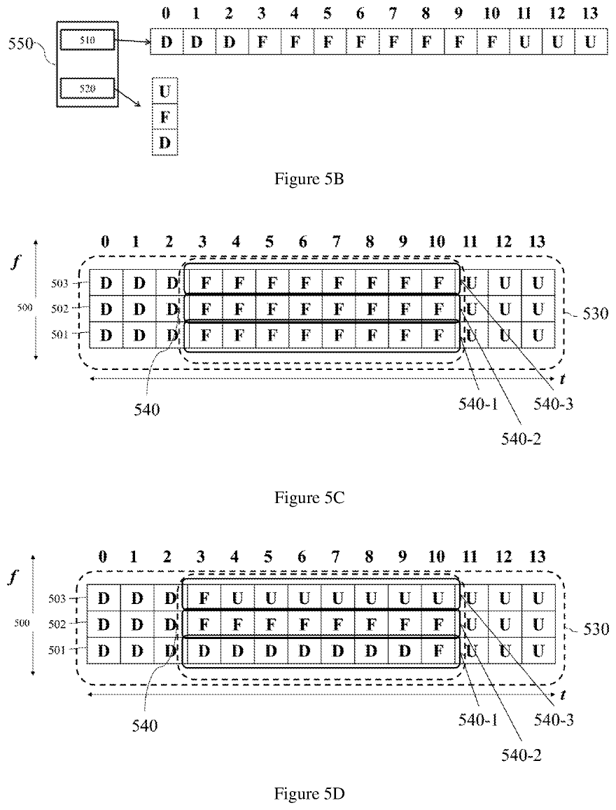

FIGS. 5A-5D illustrate some exemplary transmission direction configurations according to some embodiments of the present disclosure.

In the example shown in FIGS. 5A-5D, the UE (e.g., UE 101 in FIG. 1) determines three sub-bands, sub-band 501, sub-band 502, and sub-band 503 within the carrier 500.

FIG. 5A illustrates an exemplary set of time-frequency domain resources 530, which spans three sub-bands, sub-band 501, sub-band 502, and sub-band 503 in frequency domain, and spans one slot including 14 symbols, symbol #0 to symbol #13 in time domain. Each time-frequency domain resource in the set of time-frequency domain resources consists of one sub-band in frequency domain and one symbol in time domain. For example, the time-frequency domain resource 531 consists of sub-band 501 in frequency domain and symbol #0 in time domain, the time-frequency domain resource 532 consists of sub-band 503 in frequency domain and symbol #1 in time domain. The transmission direction for each time-frequency domain resource in the set 530 is determined according to the transmission direction configuration as shown in FIG. 5B.

For a carrier, the UE may receive a DCI message (for example, a group common DCI (GC-DCI)) including one or more indicators. The one or more indicators may include a slot format indicator (SFI), which may indicate a slot format for each slot of a number of consecutive slots. For the carrier, each slot format indicates a transmission direction for each symbol in a slot. In other words, each indicated transmission direction corresponds to a specific time-frequency domain resource which consists of a carrier in frequency domain and a symbol in time domain. In the case of there are n sub-bands within the carrier, the specific time-frequency domain resource which consists of a carrier in frequency domain and a symbol in time domain includes n time-frequency domain resources, each of which consists of a sub-band in frequency domain and a symbol in time domain, and each indicated transmission direction also corresponds to the n time-frequency domain resources. Above all, the SFI indicates a transmission direction for each time-frequency domain resource of a set of time-frequency domain resources. Each time-frequency domain resource consists of one symbol in time domain and one sub-band in frequency domain. The set of time-frequency domain resources spans the number of consecutive slots in time domain and n sub-bands in frequency domain.

The UE may be further configured by the higher layer signaling with a location of a sub-band pattern indicator (SPI) in the DCI message. Based on the configured location of the SPI, the UE may find a value of the SPI in the DCI message.

The SPI may be used for indicating a transmission direction (e.g., downlink, uplink or flexible) for each time-frequency domain resource in a first subset of the set of time-frequency domain resources, wherein a flexible transmission direction is indicated by the SFI for each time-frequency domain resource in the first subset of the set of time-frequency domain resources. One exemplary first subset is marked by the reference number 540 in FIG. 5C. The SPI may be referred to as other names, and the present disclosure has no intention of limiting the same.

The value of the SPI in the DCI message may be an index value corresponding to a sub-band pattern combination. The UE may be configured by the higher layer signaling with a set of sub-band pattern combinations. Each sub-band pattern combination in the set of slot format combinations may include:
1. one or more sub-band patterns; and
2. a mapping for the sub-band pattern combination to an index value of the corresponding SPI in the DCI message.

After receiving the DCI message in the slot, the UE may find the SPI based on the location of the SPI as configured by the higher layer signalling, and determine the value of the SPI, then determine the sub-band pattern combination corresponding to the value of the SPI. The UE may determine one or more sub-band patterns included in the sub-band pattern combination.

A sub-band pattern may include a set of fields, and the number of fields in the set of fields equals to the number of determined sub-bands within the carrier. Each field corresponds to a second subset of the first subset of the time-frequency domain resources, and each value indicates a transmission direction (including: uplink, downlink and flexible) for each time-frequency domain resource in the second subset of the first subset of time-frequency domain resources. The second subset of time-frequency domain resources spans a sub-band in frequency domain and a number of symbols in time domain. One exemplary second subset is marked by the reference number 540-1 in FIG. 5C.

One example of determining the transmission direction for each time-frequency domain resource in the set of time-frequency domain resources (marked by the reference numeral 530 in FIG. 5C and 5D) is described in FIGS. 5B to 5D. It is contemplated that the SFI 510 and SPI 520 may indicate transmission direction configuration corresponding to other time-frequency domain resources not shown in FIG. 5C and 5D.

In FIG. 5B, the UE receives the DCI message 550, which includes an SFI 510, the SFI indicates a slot format for a slot including 14 symbols (symbol #0, symbol #1, . . . , symbol #13 as shown in FIG. 5B) as “DDDFFFFFFFFUUU”, where

“D”, “F” or “U”, may indicate:
1. U: indicating an uplink transmission direction for a time-frequency domain resource which consists of a symbol marked by “U” in FIG. 5B (i.e., symbol #11, symbol #12, or symbol #13) in time domain and one of the sub-bands (i.e., sub-band 501, sub-band 502, or sub-band 503 as shown in FIG. 5C);
2. D: indicating a downlink transmission direction for a time-frequency domain resource which consists of a symbol marked by “D” in FIG. 5B (i.e., symbol #0, symbol #1, or symbol #2) in time domain and one of the sub-bands (i.e., sub-band 501, sub-band 502, or sub-band 503 as shown in FIG. 5C); or
3. F: indicating a flexible transmission direction for a time-frequency domain resource which consists of a symbol marked by “F” in FIG. 5B (i.e., symbol #3, symbol #4, . . . , symbol 9 or symbol #10) in time domain and one of the sub-bands (i.e., sub-band 501, sub-band 502, or sub-band 503 as shown in FIG. 5C).

Based on the SFI, the UE may determine a transmission direction for each time-frequency domain resource in the set of time-frequency domain resources.

FIG. 5C illustrates the determined transmission direction for each time-frequency domain resource in the set of time-frequency domain resources 530 based on the SFI. The time-frequency domain resources in the set of time-frequency domain resources for which the SFI indicates a flexible transmission direction may be considered as the first subset of time-frequency domain resources (e.g., the subset of time-frequency domain resources marked by the reference numeral 540 in the set 530 of time-frequency domain resources in FIG. 5C). The first subset of time-frequency domain resources may include a number of second subsets of time-frequency domain resources, each includes a number of time-frequency domain resources within one sub-band. In the example shown in FIG. 5C, there are three sub-bands in frequency domain, thus, there are three second subsets of time-frequency domain resources in the first subset of time-frequency domain resources. One second subset, i.e. subset 540-1 is shown in FIG. 5C.

The transmission direction corresponding to each time-frequency domain resource in the first subset 540 may be further determined by the SPI 520 which is included in the DCI message 550. The SPI may indicate an index value corresponding to a sub-band pattern combination, which includes a sub-band pattern as “UFD” for the first subset 540. It is supposed that the first field (i.e., “U”) corresponds to sub-band 503 and indicates an uplink transmission direction for each time-frequency domain resources in the subset 540-3 of time-frequency domain resources (i.e., time-frequency domain resource which consists of one of symbol #3 to symbol #10 in time domain and sub-band 503 in frequency domain), the second field (i.e., “F”) corresponds to sub-band 502 and indicates a flexible transmission direction for each time-frequency domain resources in the subset 540-2 of time-frequency domain resources (i.e., time-frequency domain resource which consists of one of symbol #3 to symbol #10 in time domain and sub-band 502 in frequency domain), and the third field (i.e., “D”) corresponds to sub-band 501 and indicates a downlink transmission direction for each time-frequency domain resources in the subset 540-1 of time-frequency domain resources (i.e., time-frequency domain resource which consists of one of symbol #3 to symbol #10 in time domain and sub-band 501 in frequency domain).

FIG. 5D illustrates the determined transmission direction for each time-frequency domain resource in the set of time-frequency domain resources 530 based on the SFI and SPI.

Based on the determined transmission direction for each time-frequency domain resource in the set of time-frequency domain resources 530 based on the SFI, the UE may further determine the transmission direction corresponding to each time-frequency domain resources in the subset 540-3 of time-frequency domain resources is uplink based on the first field of a sub-band pattern included in a sub-band pattern combination indicated by the SPI, however, since it requires a period for the UE to switch from downlink to uplink, therefore, the transmission direction corresponding to one or more time-frequency domain resources following symbol #2 may remain flexible, as shown in FIG. 5D, the transmission direction corresponding to the time-frequency domain resource which consists of symbol #3 in time domain and sub-band 503 in frequency domain remains flexible.

The UE may further determine the transmission direction corresponding to each time-frequency domain resources in the subset 540-2 (including symbol #3 to symbol #10 in time domain and sub-band 502 in frequency domain) of time-frequency domain resources is flexible based on the second field of a sub-band pattern included in a sub-band pattern combination indicated by the SPI.

The UE may further determine the transmission direction corresponding to each time-frequency domain resources in the subset 540-1 of time-frequency domain resources is downlink based on the third field of a sub-band pattern included in a sub-band pattern combination indicated by the SPI. It requires a period for the UE to switch from downlink to uplink, therefore, the transmission direction corresponding to one or more time-frequency domain resources (preceding the uplink symbol #11) may remain flexible, as shown in FIG. 5D, the transmission direction corresponding to the time-frequency domain resource which consists of symbol #10 in time domain and sub-band 501 in frequency domain remains flexible.

### Solution 2

In this solution, the UE may receive a DCI message (for example, a GC-DCI message) or a higher layer signaling, which indicates a set of sub-bands. Each sub-band is defined by a start common resource block (CRB) and a total number of the CRBs. Hereinafter the set of sub-bands is referred to as set A, and set A of the sub-bands separate another set of sub-bands in the carrier,, hereinafter referred to as set B of sub-bands, that is, the set A of sub-bands includes the indicated sub-bands while the set B of sub-bands includes the separated sub-bands.

The UE may receive a DCI message including a SFI and a SPI, the SFI may indicate one or more slot formats and each slot format corresponds to each slot of a number of consecutive slots, which is in a similar fashion as solution 1, and the details are omitted here. In other words, the SFI indicates a transmission direction for each time-frequency domain resource of a set of time-frequency domain resources. Each time-frequency domain resource consists of one symbol in time domain and one sub-band in frequency domain.

The SPI may be a bitmap having a one-to-one mapping with the sub-bands in set B, which indicates a transmission directions for each time-frequency domain resource in the first subset of the set of time-frequency domain resources, and the first subset of the set of time-frequency domain resources includes the flexible time-frequency domain resources indicated by the SFI within the separated sub-bands (i.e. sub-bands in set B).

For each bit of the bitmap, which corresponds to a sub-band in set B, a first value (for example, “0”) may indicate an uplink transmission direction for each time-frequency domain resource in a second subset of the first subset of time-frequency domain resources, wherein the second subset of time-frequency domain resource is within the corresponding sub-band in set B in frequency domain, and a second value (for example, “1”) may indicate a downlink transmission direction for each time-frequency domain resource in the second subset of the first subset of time-frequency domain resources.

Alternatively, the transmission direction for each time-frequency domain resource in the second subset of time-frequency domain resources may be determined based on a predefined rule.

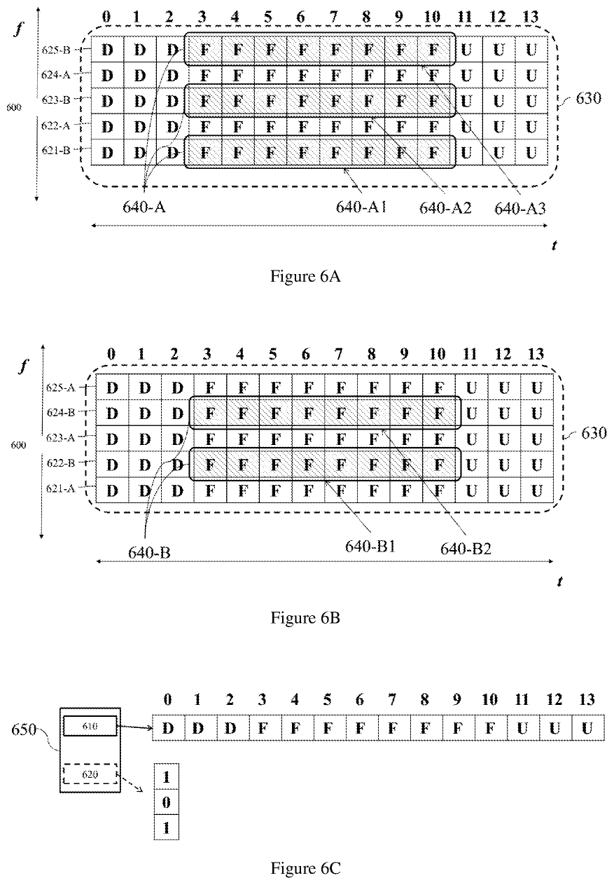

For example, FIGS. 6A-6D illustrate some exemplary transmission direction configurations according to some embodiments of the present disclosure.

In FIG. 6A, based on a DCI message 650 or a higher layer signalling, the UE may determine a set of sub-bands in a carrier. For example, in FIG. 6A, the UE determines sub-band 622 and sub-band 624 in a carrier 600. The two sub-bands separate the other three sub-bands in the carrier 600, i.e. sub-band 621, sub-band 623 and sub-band 625, so set A of sub-bands includes the indicated sub-bands, i.e. sub-band 622-A and sub-band 624-A, and set B of sub-bands includes the separated sub-bands, i.e. sub-band 621-B, sub-band 623-B, and sub-band 625-B.

In FIG. 6B, the UE may determine sub-band 621, sub-band 623, and sub-band 625 in the carrier 600, and the three sub-bands separate the other two sub-bands in the carrier 600, i.e. sub-band 622 and sub-band 624, and set A of sub-bands includes the indicated sub-bands, i.e. 621-A, sub-band 623-A, and sub-band 625-A, and set B of sub-bands includes the separated sub-bands, i.e. sub-band 622-B, and sub-band 624-B.

FIG. 6C illustrates a transmission direction configuration corresponding to FIG. 6A. As shown in FIG. 6C, the UE may receive a DCI message 650 including an SFI 610, which indicates a slot format for a slot including 14 symbols (symbol #0, symbol #1, . . . , symbol #13 as shown in FIG. 6C) as “DDDFFFFFFFFUUU”, where “D”, “F” or “U”, may indicate:
1. U: indicating an uplink transmission direction for a time-frequency domain resource which consists of a symbol marked by “U” in FIG. 6C (i.e., symbol #11, symbol #12, or symbol #13) in time domain and one of the sub-bands (i.e., sub-band 621-B, sub-band 622-A, sub-band 623-B, sub-band 624-A or sub-band 625-B as shown in FIG. 6A);
2. D: indicating a downlink transmission direction for a time-frequency domain resource which consists of a symbol marked by “D” in FIG. 6C (i.e., symbol #0, symbol #1, or symbol #2) in time domain and one of the sub-bands (i.e., sub-band 621-B, sub-band 622-A, sub-band 623-B, sub-band 624-A or sub-band 625-B as shown in FIG. 6A); or
3. F: indicating a flexible transmission direction for a time-frequency domain resource which consists of a symbol marked by “D” in FIG. 6C (i.e., symbol #3, symbol #4, . . . , or symbol #10) in time domain and one of the sub-bands (i.e., sub-band 621-B, sub-band 622-A, sub-band 623-B, sub-band 624-A or sub-band 625-B as shown in FIG. 6A).

It is contemplated that the SFI 610 and SPI 620 may also indicate transmission direction configurations corresponding to other time-frequency domain resources in addition to the configurations as shown in FIG. 6A and 6B.

Optionally, the DCI message 650 further includes an SPI 620, which may be a bitmap having a one-to-one mapping with the sub-bands in set B (i.e., sub-band 621-B, sub-band 623-B, and sub-band 625-B as shown in FIG. 6A) and the bitmap indicates “101,” wherein the value “1” may indicate the one transmission direction, and the value “0” may indicate another transmission direction. The SPI indicates a transmission direction for each time-frequency domain resource in a first subset of the set of time-frequency domain resources, and the first subset of the set of time-frequency domain resources includes the flexible time-frequency domain resources indicated by the SFI within the separated sub-bands (i.e., sub-bands in set B). In particular, in FIG. 6A, the SPI may indicate a transmission direction for each time-frequency domain resource in the first subset of time-frequency domain resources 640-A. For each bit of the bitmap, which corresponds to a sub-band in set B, a value of the bit may indicate a transmission direction for each time-frequency domain resource in a second subset of the first subset of time-frequency domain resources, wherein the second subset of time-frequency domain resource is within the corresponding sub-band in set B in frequency domain. For example, in FIG. 6A, the flexible time-frequency domain resources within sub-band 621-B belong to a second subset of time-frequency domain resources (marked by reference numeral 640-A1), and a transmission direction of each time-frequency domain resource in subset 640-A1 is indicated by a corresponding bit of the bitmap. Similarly, the flexible time-frequency domain resources within sub-band 623-B belong to another second subset of time-frequency domain resources (marked by reference numeral 640-A2), and a transmission direction corresponding to each time-frequency domain resource in subset 640-A2 is indicated by a corresponding bit of the bitmap. The flexible time-frequency domain resources within sub-band 625-B belong to still another second subset of time-frequency domain resources (marked by reference numeral 640-A3), and a transmission direction corresponding to each time-frequency domain resource in subset 640-A3 is indicated by a corresponding bit of the bitmap.

In FIG. 6B, the flexible time-frequency domain resources within sub-band 622-B belong to a second subset of time-frequency domain resources (marked by reference numeral 640-B1), and a transmission direction corresponding to each time-frequency domain resource in the second subset 640-B1 is indicated by a corresponding bit of the bitmap. The flexible time-frequency domain resources within sub-band 624-B belong to another second subset of time-frequency domain resources (marked by reference numeral 640-B2), and a transmission direction corresponding to each time-frequency domain resource in the second subset 640-B2 is indicated by a corresponding bit of the bitmap.

For FIG. 6A, it is supposed that the first value of “0” corresponds to sub-band 623-B and indicates an uplink transmission direction for each time-frequency domain resources in the second subset 640-A2; the second value of “1” corresponds to sub-band 621-B and 625-B and indicates a downlink transmission direction for each time-frequency domain resources in the second subset 640-A1 and the second subset 640-A3. It should be noted that the value “1” may indicate a downlink transmission direction, and the value “0” may indicate the uplink transmission direction.

Therefore, the UE may further determine the transmission direction for each time-frequency domain resource in the second subset 640-A2 (i.e., time-frequency domain resources which consists of one symbol of symbol #3 to symbol #10 in time domain and sub-band 623-B in frequency domain) is uplink, however, since it requires a period for the UE to switch from downlink to uplink, therefore, one or more time-frequency domain resources (following symbol #2) may remain flexible. For example, as shown in FIG. 6D, the transmission direction corresponding to the time-frequency domain resource 631 which consists of symbol #3 in time domain and sub-band 623-B in frequency domain remains flexible.

The UE may further determine the transmission direction for each time-frequency domain resource in the second subset 640-A1 (i.e., time-frequency domain resources which consists of one symbol of symbol #3 to symbol #10 in time domain and sub-band 621-B in frequency domain) and the second subset 640-A3 (i.e., time-frequency domain resources from symbol #3 to symbol #10 in time domain and sub-band 625-B in frequency domain) is downlink. It requires a period for the UE to switch from downlink to uplink, therefore, one or more time-frequency domain resources (preceding the uplink symbol #11) may remain flexible. For example, as shown in FIG. 6D, the transmission direction corresponding to the time-frequency domain resource 632 which consists of symbol #10 in time domain and sub-band 621-B in frequency domain remains flexible. The transmission direction corresponding to the time-frequency domain resource 633 which consists of symbol #10 in time domain and sub-band 625-B in frequency domain remains flexible.

Alternatively, in the case that the DCI message 650 does not include an SPI 620, the UE may determine a transmission direction for each time-frequency domain resources in the first subset of the set of time-frequency domain resources, and the first subset of the set of time-frequency domain resources includes the flexible time-frequency domain resources indicated by the SFI within the separated sub-bands (i.e. sub-bands in set B) based on a predefined rule.

Based on the solutions, the UE may determine the transmission direction corresponding to a time-frequency domain resource is:
1. uplink in the following cases:
   i. the SFI indicates the transmission direction corresponding to the time-frequency domain resource is uplink; or
   ii. the SFI indicates the transmission direction corresponding to the time-frequency domain resource is flexible and the SPI indicates the transmission direction corresponding to the time-frequency domain resource is uplink;
2. downlink in the following cases:
   i. the SFI indicates the transmission direction corresponding to the time-frequency domain resource is downlink; or
   ii. the SFI indicates the transmission direction corresponding to the time-frequency domain resource is flexible and the SPI indicates the transmission direction corresponding to the time-frequency domain resource is downlink; or
3. flexible in the following cases:
   i. both the SFI and the SPI indicate the transmission direction corresponding to the time-frequency domain resource is flexible.
   ii. the SFI indicates the transmission direction corresponding to the time-frequency domain resource is flexible and the SPI doesn't indicate the transmission direction corresponding to the time-frequency domain resource, that is, the time-frequency domain resource is not included in the first subset of the set of time-frequency domain resources.

If the UE is configured by a higher layer to perform a downlink reception on a set of REs within a set of time-frequency domain resource, the UE performs the downlink reception if the UE determines the transmission direction corresponding to each time-frequency domain resource in the set of time-frequency domain resource is downlink.

If the UE is configured by a higher layer to perform an uplink transmission on a set of REs within a set of time-frequency domain resource, the UE performs the uplink transmission if the UE determines the transmission direction corresponding to each time-frequency domain resource in the set of time-frequency domain resource is uplink.

In some embodiments, the UE may be scheduled to perform downlink reception or uplink transmission within different sub-bands. In some cases, there might be resource collision for different transmissions.

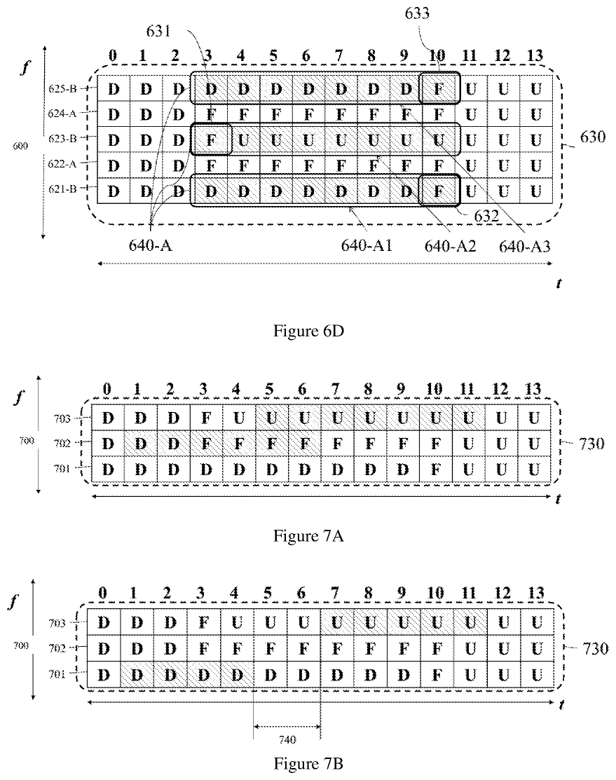

FIGS. 7A and 7B illustrate some exemplary cases of resource collision according to some embodiments of the present disclosure.

In FIGS. 7A and 7B, the UE determines three sub-band, sub-band 701, sub-band 702, and sub-band 703 within a carrier 700. The UE also determines a transmission direction for each time-frequency domain resource in the set of time-frequency domain resources 730.

In FIG. 7A, the UE is scheduled to perform uplink transmission on a set of REs which spans symbol #5 to symbol #11 in time domain and sub-band 703 in frequency domain, and is also scheduled to perform downlink reception on a set of REs which spans symbol #1 to symbol #6 in time domain and sub-band 702 in frequency domain. As can be seen, the two transmissions overlap in symbol #5 and symbol #6 in time domain, and the UE may not be capable of performing full duplex, thus there is a resource collision between the two transmissions.

In FIG. 7B, the UE is scheduled to perform uplink transmission on a set of REs which spans symbol #7 to symbol #11 in time domain and sub-band 703 in frequency domain, and is also scheduled to perform downlink reception on a set of REs which spans symbol #1 to symbol #4 in time domain and sub-band 701 in frequency domain. As can be seen, there is a time gap 740 between two transmissions. It is supposed that the UE may need a period, such as a switch time “t”, to switch from downlink to uplink (or from uplink to downlink), which may be larger than the time gap 740, in this case, there is a resource collision between the two transmissions.

In some embodiments, the UE may perform the transmission which has the earlier starting time, for example, as shown in FIG. 7A, the downlink reception in sub-band 702 starts at symbol #1, which is earlier than symbol #5, thus the UE may perform the downlink reception and drop the uplink transmission.

In some other embodiments, the UE may determine the priority level associated with the downlink reception or uplink transmission by a pre-defined rule, or by some explicit or implicit indications.

For example, the UE may be indicated by a DCI to perform a physical uplink control channel (PUCCH) transmission carrying a hybrid automatic repeat-acknowledge (HARQ-ACK) corresponding to a DL reception, and the UE may also be indicated by a higher layer signaling to perform a channel state information-reference signals (CSI-RS) reception. Furthermore, there is a resource collision between the PUCCH transmission and the CSI-RS reception. According to the pre-defined rule, the UE is aware that the PUCCH transmission carrying a HARQ-ACK has a higher priority level than the CSI-RS reception, therefore, the UE may perform the PUCCH transmission and drop and CSI-RS reception.

In some other embodiments, the UE may be indicated to perform an uplink transmission on the first set of REs with the first priority level, and may also be indicated to perform a downlink reception on the second set of REs with the second priority level.

In the case that there is a resource collision between the uplink transmission and the downlink reception, the UE may compare the values of the first priority level and the second priority level. If the first priority level is higher than the second priority level, the UE will perform the UL transmission on the first set of REs and drop the downlink reception on the second set of REs. If the first priority level is lower than the second priority level, the UE may drop the UL transmission on the first set of REs and may perform the DL reception on the second set of REs.

In some embodiments, the UE may report the UE capability of a switching time “t” for switching from uplink transmission to downlink reception, or from downlink reception to uplink transmission to the BS. Thus the BS may take the UE capability into consideration, to avoid scheduling transmissions or receptions which exceeds the UE capability.

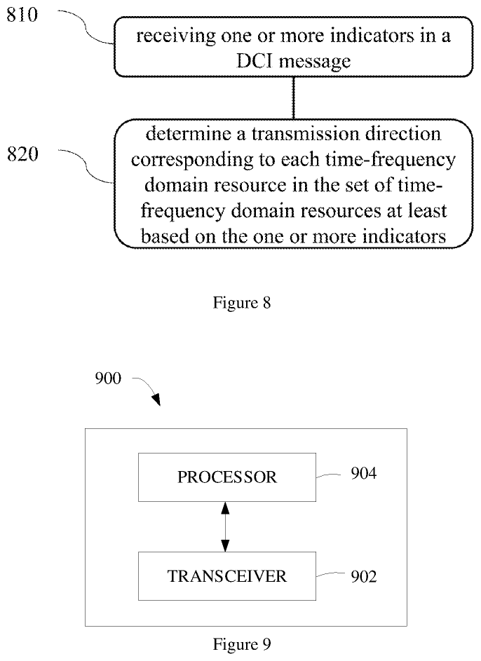

FIG. 8 illustrates a flow chart of an exemplary procedure of wireless communications in accordance with some embodiments of the present disclosure.

In operation 810, the UE may receive one or more indicators in a DCI message, wherein the one or more indicators indicate a transmission direction configuration for a set of time-frequency domain resources. In operation 820, the UE may determine a transmission direction corresponding to each time-frequency domain resource in the set of time-frequency domain resources at least based on the one or more indicators, wherein each time-frequency domain resource consists of one sub-band in frequency domain and one symbol in time domain

In some embodiments, the one or more indications include a slot format indicator (SFI), and wherein the SFI indicates a transmission direction for each time-frequency domain resource in the set of time-frequency domain resources. For example, as shown in FIG. 5A, the SFI indicates a transmission direction for each time-frequency domain resource in the set of time-frequency domain resources 530, and in the solution in FIG. 6A, the SFI indicates a transmission direction for each time-frequency domain resource in the set of time-frequency domain resources 630.

In some embodiments, the one or more indications further include an SPI indicating a transmission direction for each time-frequency domain resource in a first subset of the set of time-frequency domain resources. In some embodiments, the SPI indicates one or more sub-band patterns, wherein each sub-band pattern includes a set of fields, and each field indicates a transmission direction for each time-frequency domain resource in a second subset of the first subset of time-frequency domain resources. For example, as shown in FIG. 5A, the SPI indicates the transmission direction for each time-frequency domain resource in a first subset of the set of time-frequency domain resources 540. As shown in FIG. 5B, the field “D” in the set of fields indicates the transmission direction for each time-frequency domain resource in one second subset 540-1.

In some embodiments, in the case that the SFI indicates a first transmission direction corresponding to a first time-frequency domain resource, the UE may determine the transmission direction corresponding to the first time-frequency domain resource is the first transmission direction. The first transmission direction may be the uplink transmission direction, or the downlink transmission direction. For example, in FIG. 6A, the SFI indicates the downlink transmission direction for the time-frequency domain resource which consists of symbol #1 in time domain and sub-band 625-A in frequency domain, and the UE determines the transmission direction corresponding to the time-frequency domain resource which consists of symbol #1 in time domain and sub-band 625-A in frequency domain is downlink.

In some embodiments, in the case that the SFI indicates a second transmission direction corresponding to a second time-frequency domain resource, and the SPI indicates the first transmission direction or the second transmission direction corresponding to the second time-frequency domain resource, the UE may determine the transmission direction corresponding to the second time-frequency domain resource is the first transmission direction or the second transmission direction as indicated by the SPI, wherein the second time-frequency domain resource is included in the first subset of the set of time-frequency domain resources. The second transmission direction may be the flexible transmission direction. For example, in FIG. 6D, the SFI indicates the flexible transmission direction for the time-frequency domain resource which consists of symbol #5 in time domain and sub-band 621-A in frequency domain, and the SPI indicates the transmission direction for the same time-frequency domain resource as downlink, the UE determines the transmission direction corresponding to the time-frequency domain resource which consists of symbol #5 in time domain and sub-band 501 in frequency domain is downlink, as indicate by the SPI.

In some embodiments, in the case that the SFI indicates the second transmission direction (i.e. a flexible transmission direction) corresponding to a third time-frequency domain resource, the UE may determine the transmission direction of the third time-frequency domain resource is the second transmission direction, wherein the third time-frequency domain resource is not included in the first subset of the set of time-frequency domain resources,. For example, in FIG. 6D, the SFI indicates the flexible transmission direction for the time-frequency domain resource which consists of symbol #3 in time domain and sub-band 624-A infrequency domain, which is not included in the first subset 640-A, and the UE determines the transmission direction corresponding to the time-frequency domain resource which consists of symbol #3 in time domain and sub-band 624-B in frequency domain is flexible.

In some embodiments, the UE may determine a transmission direction corresponding to each time-frequency domain resource in a second subset of the set of time-frequency domain resources based on a pre-defined rule. For example, the UE may determine the transmission direction for each time-frequency domain resource in a second subset 640 as flexible according to the pre-defined rule.

In some embodiments, the UE may determine a first priority level associated with a first transmission on a first set of REs, may determine a second priority level associated with a second transmission on a second set of REs; and perform a transmission with a higher priority level among the first transmission and the second transmission in response to a resource collision being present between the first transmission and the second transmission. In some embodiments, the resource collision is caused by a time gap between the first set of REs and the second set of REs in time domain being less than a preconfigured duration, for example, the time gap 740 as shown in FIG. 7B is less than the preconfigured duration. In some embodiments, the resource collision is caused by the first set of REs and the second set of REs at least partially overlapped in time domain. For example, the resource collision in FIG. 7A is caused by the REs for the uplink transmission from symbol #5 to symbol #11 in sub-band 703 and the REs for the downlink transmission from symbol #1 to symbol #6 in sub-band 703 overlap in time domain.

In some other embodiments, the BS may transmit the DCI message including one or more indicators, wherein the one or more indicators indicate a transmission direction configuration for a set of time-frequency domain resources.

FIG. 9 illustrates a simplified block diagram of an exemplary apparatus according to some embodiments of the present disclosure.

As shown in FIG. 9, the apparatus 900 may include at least one processor 904 and at least one transceiver 902 coupled to the processor 904. The apparatus 900 may be or include at least part of a UE or a BS.

Although in this figure, elements such as the transceiver 902 and the processor 904 are described in the singular, the plural is contemplated unless a limitation to the singular is explicitly stated. In some embodiments of the present disclosure, the transceiver 902 may be divided into two devices, such as a receiving circuitry and a transmitting circuitry. In some embodiments of the present disclosure, the apparatus 900 may further include an input device, a memory, and/or other components.

In some embodiments of the present disclosure, the apparatus 900 may be a UE. The transceiver 902 and the processor 904 may interact with each other so as to perform the operations of the UE described with respect to any of FIGS. 1-8. In some embodiments of the present disclosure, the apparatus 900 may be a BS. The transceiver 902 and the processor 904 may interact with each other so as to perform the operations of the BS described with respect to any of FIGS. 1-8.

In some embodiments of the present disclosure, the apparatus 900 may further include at least one non-transitory computer-readable medium.

For example, in some embodiments of the present disclosure, the non-transitory computer-readable medium may have stored thereon computer-executable instructions to cause the processor 904 to implement any method performed by the UE as described above. For example, the computer-executable instructions, when executed, may cause the processor 904 interacting with the transceiver 902 to perform the operations of the UE described with respect to any of FIGS. 1-8.

In some embodiments of the present disclosure, the non-transitory computer-readable medium may have stored thereon computer-executable instructions to cause the processor 904 to implement any method performed by the BS as described above. For example, the computer-executable instructions, when executed, may cause the processor 904 interacting with the transceiver 902 to perform the operations of the BS described with respect to any of FIGS. 1-8.

The method of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each figure are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

In this disclosure, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

What is claimed is:

1. A user equipment (UE) for wireless communication, comprising:
at least one memory; and
at least one processor coupled with the at least one memory and configured to cause the UE to:
receive one or more indicators in a downlink control information (DCI) message, wherein the one or more indicators indicate a transmission direction configuration for a set of time-frequency domain resources; and
determine a transmission direction corresponding to each time-frequency domain resource in the set of time-frequency domain resources at least based on the one or more indicators,
wherein each time-frequency domain resource comprises one sub-band in frequency domain and one symbol in time domain.

2. The UE of claim 1, wherein the one or more indicators include a slot format indicator (SFI), and wherein the SFI indicates a transmission direction for each time-frequency domain resource in the set of time-frequency domain resources.

3. The UE of claim 2, wherein the one or more indicators further include a sub-band pattern indicator (SPI) indicating a transmission direction for each time-frequency domain resource in a first subset of the set of time-frequency domain resources.

4. The UE of claim 3, wherein the SPI indicates one or more sub-band patterns, wherein each sub-band pattern includes a set of fields, and wherein each field indicates a transmission direction for each time-frequency domain resource in a second subset of the first subset of time-frequency domain resources.

5. The UE of claim 4, wherein the at least one processor is configured to cause the UE to one or more of:
in a case that the SFI indicates a first transmission direction corresponding to a first time-frequency domain resource, determine the transmission direction corresponding to the first time-frequency domain resource is the first transmission direction;
in a case that the SFI indicates a second transmission direction corresponding to a second time-frequency domain resource, and the SPI indicates the first transmission direction or the second transmission direction corresponding to the second time-frequency domain resource, determine the transmission direction of the second time-frequency domain resource is the first transmission direction or the second transmission direction as indicated by the SPI, wherein the second time-frequency domain resource is included in the first subset of the set of time-frequency domain resources; or
in a case that the SFI indicates the second transmission direction corresponding to a third time-frequency domain resource, determine the transmission direction of the third time-frequency domain resource is the second transmission direction, wherein the third time-frequency domain resource is not included in the first subset of the set of time-frequency domain resources.

6. The UE of claim 3, wherein the at least one processor is configured to cause the UE to:
determine a transmission direction for each time-frequency domain resource in a second subset of the first subset of time-frequency domain resources based on a pre-defined rule.

7. The UE of claim 1, wherein the at least one processor is configured to cause the UE to:
determine a first priority level associated with a first transmission on a first set of resource elements (REs);
determine a second priority level associated with a second transmission on a second set of REs; and
perform a transmission with a higher priority level among the first transmission and the second transmission in response to a resource collision being present between the first transmission and the second transmission.

8. The UE of claim 7, wherein the resource collision is determined based on at least one of:
a time gap between the first set of REs and the second set of REs in time domain being less than a preconfigured duration; or
the first set of REs and the second set of REs at least partially overlapped in time domain.

9. A base station for wireless communication, comprising:
at least one memory; and
at least one processor coupled with the at least one memory and configured to cause the base station to:
transmit a downlink control information (DCI) message including one or more indicators, wherein the one or more indicators indicate a transmission direction configuration for a set of time-frequency domain resources.

10. The base station of claim 9, wherein the one or more indicators include a slot format indicator (SFI), and wherein the SFI indicates a transmission direction for each time-frequency domain resource in the set of time-frequency domain resources.

11. The base station of claim 10, wherein the one or more indicators further include a sub-band pattern indicator (SPI) indicating a transmission direction for each time-frequency domain resource in a first subset of the set of time-frequency domain resources.

12. The base station of claim 11, wherein the SPI indicates one or more sub-band patterns, wherein each sub-band pattern includes a set of fields, and wherein each field indicates a transmission direction for each time-frequency domain resource in a second subset of the first subset of time-frequency domain resources.

13. A method performed by a user equipment (UE), the method comprising:
receiving one or more indicators in a downlink control information (DCI) message, wherein the one or more indicators indicate a transmission direction configuration for a set of time-frequency domain resources; and
determining a transmission direction corresponding to each time-frequency domain resource in the set of time-frequency domain resources at least based on the one or more indicators, wherein each time-frequency domain resource comprises one sub-band in frequency domain and one symbol in time domain.

14. The method of claim 13, wherein the one or more indicators include a slot format indicator (SFI), and wherein the SFI indicates a transmission direction for each time-frequency domain resource in the set of time-frequency domain resources.

15. The method of claim 13, wherein the one or more indicators further include a sub-band pattern indicator (SPI) indicating a transmission direction for each time-frequency domain resource in a first subset of the set of time-frequency domain resources.

16. A processor for wireless communication, comprising:
at least one controller coupled with at least one memory and configured to cause the processor to:
receive one or more indicators in a downlink control information (DCI) message, wherein the one or more indicators indicate a transmission direction configuration for a set of time-frequency domain resources; and
determine a transmission direction corresponding to each time-frequency domain resource in the set of time-frequency domain resources at least based on the one or more indicators,
wherein each time-frequency domain resource comprises one sub-band in frequency domain and one symbol in time domain.

17. The processor of claim 16, wherein the one or more indicators include a slot format indicator (SFI), and wherein the SFI indicates a transmission direction for each time-frequency domain resource in the set of time-frequency domain resources.

18. The processor of claim 17, wherein the one or more indicators further include a sub-band pattern indicator (SPI) indicating a transmission direction for each time-frequency domain resource in a first subset of the set of time-frequency domain resources.

19. The processor of claim 18, wherein the SPI indicates one or more sub-band patterns, wherein each sub-band pattern includes a set of fields, and wherein each field indicates a transmission direction for each time-frequency domain resource in a second subset of the first subset of time-frequency domain resources.

20. The processor of claim 19, wherein the at least one controller is configured to cause the processor to one or more of:
in a case that the SFI indicates a first transmission direction corresponding to a first time-frequency domain resource, determine the transmission direction corresponding to the first time-frequency domain resource is the first transmission direction;
in a case that the SFI indicates a second transmission direction corresponding to a second time-frequency domain resource, and the SPI indicates the first transmission direction or the second transmission direction corresponding to the second time-frequency domain resource, determine the transmission direction of the second time-frequency domain resource is the first transmission direction or the second transmission direction as indicated by the SPI, wherein the second time-frequency domain resource is included in the first subset of the set of time-frequency domain resources; or
in a case that the SFI indicates the second transmission direction corresponding to a third time-frequency domain resource, determine the transmission direction of the third time-frequency domain resource is the second transmission direction, wherein the third time-frequency domain resource is not included in the first subset of the set of time-frequency domain resources.
